(19) United States
(12) Patent Application Publication
(10) Pub. No.: US 2007/0067510 A1
(43) Pub. Date: Mar. 22, 2007

(54) I/O configuration, and logging of resources associated with I/O open requests

(76) Inventor: David Kline Gladfelter, Fort Collins, CO (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/233,431

(22) Filed: Sep. 22, 2005

(51) Int. Cl. G06F 3/00

(52) U.S. Cl. 710/39

(57) ABSTRACT

In one embodiment, a computer-implemented method for configuring I/O monitors I/O open requests. Upon failure of an I/O open request directed to a first resource, configured I/O interfaces are analyzed to attempt to identify a second resource capable of handling the I/O open request; and if the second resource is identified, future I/O open requests directed to the first resource are caused to be redirected to the second resource. In another embodiment, a computer-implemented method monitors I/O open requests issued by a number of applications; logs resources opened in response to the I/O open requests; and stores associations between i) each of the number of applications, and ii) the resources logged for the application's I/O open requests. Other embodiments are also disclosed.

### BACKGROUND

Often, engineers do not understand the I/O configuration needs of their applications. Nor do they know how to configure I/O to meet the needs of their applications.

The Agilent I/O Libraries (distributed by Agilent Technologies, Inc.) allow engineers to manually configure their I/O. However, this requires knowledge that engineers typically do not have (and do not wish to learn).

I/O configuration can be especially troublesome when changing the configuration of a computer system, or when deploying a customized application to a new computer system.

### SUMMARY OF THE INVENTION

In one embodiment, a computer-implemented method for configuring I/O comprises monitoring I/O open requests. Upon failure of an I/O open request directed to a first resource, configured I/O interfaces are analyzed to attempt to identify a second resource capable of handling the I/O open request. If the second resource is identified, future I/O open requests directed to the first resource are caused to be redirected to the second resource.

In another embodiment, a computer-implemented method comprises monitoring I/O open requests issued by a number of applications; logging resources opened in response to the I/O open requests; and storing associations between i) each of the number of applications, and ii) the resources logged for the application's I/O open requests.

Other embodiments are also disclosed.

### BRIEF DESCRIPTION OF THE DRAWINGS

Illustrative embodiments of the invention are illustrated in the drawings, in which:

FIG. 1 illustrates a simplified block diagram of various aspects of an exemplary computer system;

FIG. 2 illustrates an exemplary computer-implemented method for configuring I/O;

FIG. 3 illustrates an exemplary utility in which the FIG. 2 method may be embodied;

FIG. 4 illustrates an exemplary graphical user interface that may be associated with the method of FIG. 2;

FIG. 5 illustrates an exemplary method for logging resources that are accessed in response to I/O open requests issued by a number of applications; and

FIG. 6 illustrates an exemplary utility in which the FIG. 5 method may be embodied.

### DETAILED DESCRIPTION

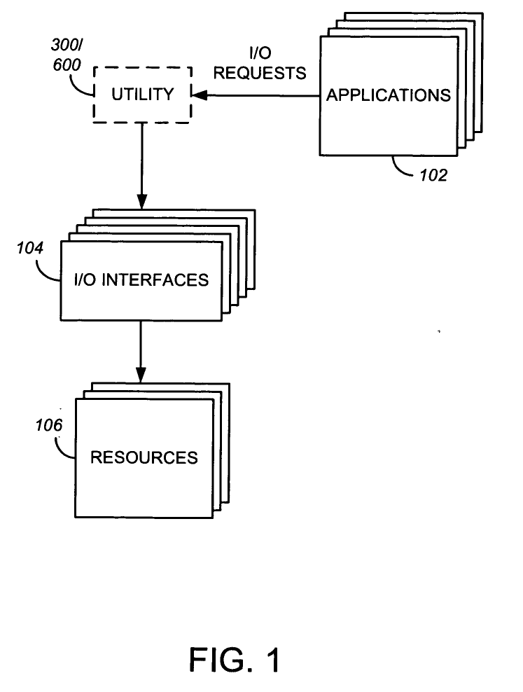

FIG. 1 illustrates a simplified block diagram of various aspects of an exemplary computer system 100. As shown, the computer system 100 is provided with a number of input/output (I/O) interfaces 104 and has a number applications 102 installed thereon. During operation of the computer system 100, different ones of the applications 102 may access or control resources 106 that are connected to the I/O interfaces 104. The resources 106 may be accessed and controlled by means of I/O requests that are issued by the applications 102. A utility 300/600 that receives and filters some or all of the I/O requests will be discussed later in this description.

In one embodiment, the applications 102 installed on the computer system 100 may comprise test and measurement applications, and the resources 106 that they access and control may comprise test and measurement instruments. By way of example, the I/O interfaces 104 may comprise Universal Serial Bus (USB), Local Area Network (LAN), General Purpose Instrument Bus (GPIB), Recommended Standard 232 (RS-232) and Virtual machine environment extensions for Instrumentation (VXI) interfaces. In a test and measurement environment, the I/O requests may comprise National Instruments 488.2 (NI-488.2) and Virtual Instrument System Architecture/Standard Instruments Control Library (VISA/SICL) I/O requests.

When deploying a new application on a computer system such as the system 100, or when connecting a new or different resource to the system 100 (including, possibly, a repaired resource), it may be necessary to configure or reconfigure the application's I/O. That is, it may be necessary to inform the application as to which I/O interfaces it needs to address to access certain resources, or it may be necessary to establish a mapping between the resources an application desires to communicate with and the I/O interfaces through which the resources may be accessed. It may also be necessary to translate an application's I/O requests so that they are compatible with a particular I/O interface's communication protocol.

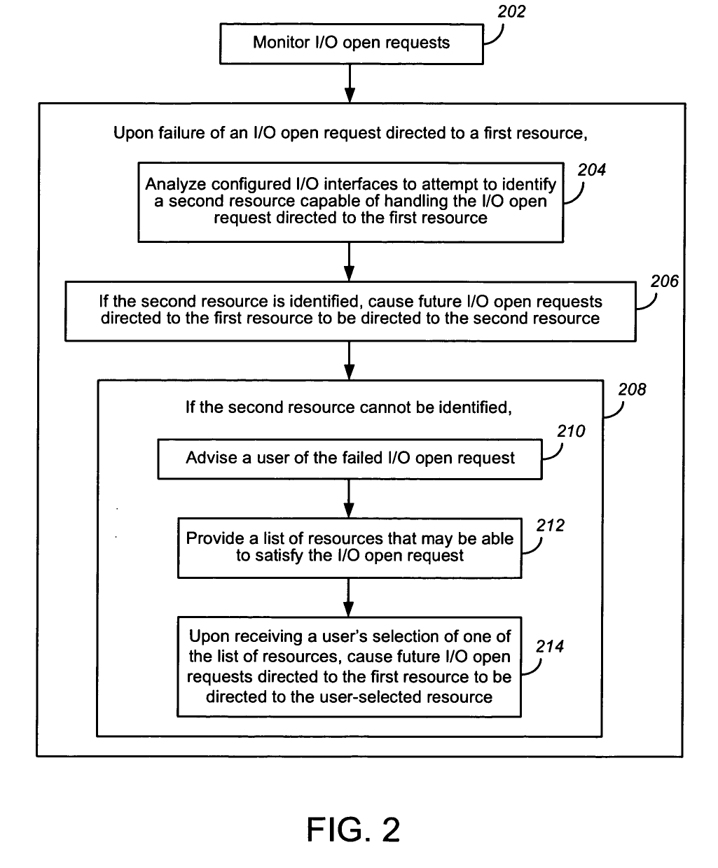

To assist in configuring an application's I/O, FIG. 2 illustrates an exemplary computer-implemented method 200 for configuring I/O. The method 200 comprises monitoring 202 1/O open requests (e.g., requests to access resources). Upon failure of an I/O open request directed to a first resource (e.g., because the first resource is disabled or absent), the method 200 proceeds to analyze 204 configured I/O interfaces in an attempt to identify a second resource that is capable of handling the I/O open request. If a second resource can be identified, future I/O open requests directed to the first resource are caused 206 to be redirected to the second resource.

The attempt to identify the second resource may be conducted in a variety of ways. In one embodiment, the attempt is made by searching for a resource whose identification only varies from that of the first resource by interface number (e.g., an attempt may be made to identify the same resource or resource type on I/O interface GPIB_1 instead of GPIB_0).

In one embodiment, future I/O open requests directed to the first resource are caused to be directed to the second resource by changing an identifier of an I/O interface corresponding to the second resource, so that it matches that of an I/O interface that previously corresponded to the first resource. In another embodiment, the I/O open requests are redirected by creating an alias to associate the name of the first resource with the second resource.

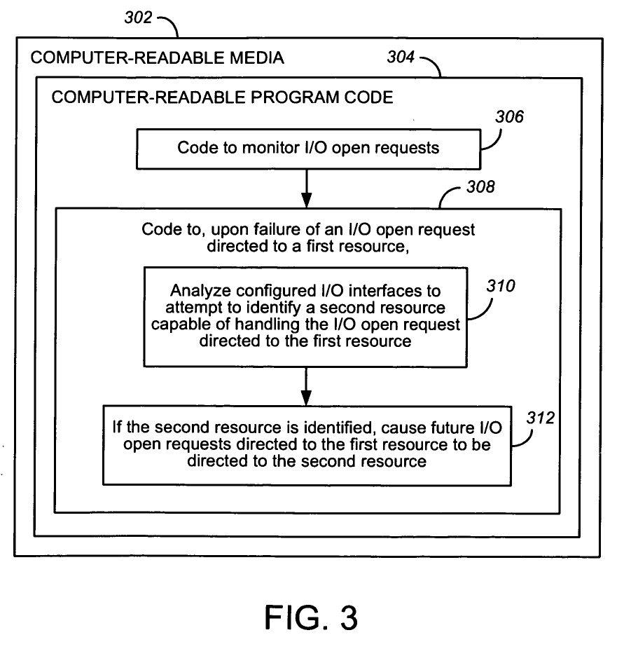

In one embodiment, the method 200 is implemented by an I/O configuration utility 300 (FIG. 3). As shown, the utility 300 may be embodied in computer-readable program code 304 stored on a number of computer-readable media 302. By way of example, the computer-readable media 302 may comprise one or more fixed or removable media, such as one or more read-only memories (ROMs), random-access memories (RAMs), hard disks or compact discs. Also, the media 302 may be located in one place, or distributed over different nodes of a network. By way of further example, the computer-readable program code may take the form of software or firmware.

As shown in FIG. 3, the computer-readable program code 304 may comprise code 306 to monitor I/O open requests, and code 308 to, upon failure of an I/O open request directed to a first resource, 1) analyze 310 configured I/O interfaces to attempt to identify a second resource capable of handling the I/O open request, and 2) if the second resource is identified, cause 312 future I/O open requests that are directed to the first resource to be directed to the second resource.

Various alternative and optional embodiments of the method 200 and utility 300 will now be described.

In one embodiment, if the method 200 or utility 300 cannot identify a suitable second resource 208, a user may be advised 210 of the failed I/O open request and provided 212 a list of resources that may be able to satisfy the I/O open request. By way of example, the method 200 or utility 300 may not be able to identify a suitable resource if 1) it cannot identify any resource, or 2) it happens to identify more than one suitable resource.

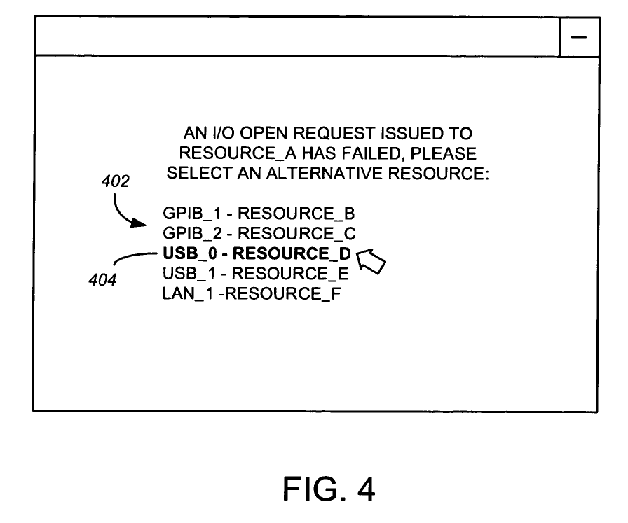

As shown in FIG. 4, the user may be advised 210 of the failed I/O open request via a window of a graphical user interface (GUI) 400. Then, upon receiving a user's selection of one 404 of the list of resources 402, future I/O open requests directed to the first resource are caused 214 to be directed to the user-selected resource 404. This may be done, for example, by changing an identifier of an I/O interface corresponding to the selected one of the resources may be changed to match that of an I/O interface that previously corresponded to the first resource. Alternately, an alias may be created to associate the name of the first resource with the resource selected by the user.

In some cases, the method 200 or utility 300 may create a temporary alias upon receipt of the user's selection of a resource. The temporary alias may be created by default, or as a result of user preference (e.g., as a result of user selection of an option displayed through the GUI 400). Upon creation of the temporary alias, I/O commands that are issued to the resource may be logged; and any data that is transmitted in response to the I/O commands may be displayed to the user. Then, if the user recognizes the data as being consistent with what would have been transmitted to/from the first resource (assuming that it had not failed), the user may choose to make the temporary alias a permanent alias (e.g., by selecting an option displayed through the GUI 400). In one embodiment, a user is prompted, upon selection of a resource from the list of resources or upon display of the list of resources, to indicate whether the user's selection is temporary or permanent—thereby leading to the creation of a temporary or permanent alias. If the user selects to make an alias permanent, command logging need not be performed.

The monitoring of I/O open requests may be performed on a continuous basis. Alternately, the monitoring may be automatically initiated upon boot of a computer system, upon change of a computer system's connected resources, or upon deployment of a new application on a computer system. In one embodiment, the method 200 or utility 300 is performed or invoked during a learning mode of the method 200 or utility 300. The learning mode may be automatically initiated upon one of the afore-mentioned events (e.g., automatic detection of a change in connected resources, or the deployment of a new application), or it may be launched by selecting an appropriate menu option (or pressing an icon) of the GUI 400.

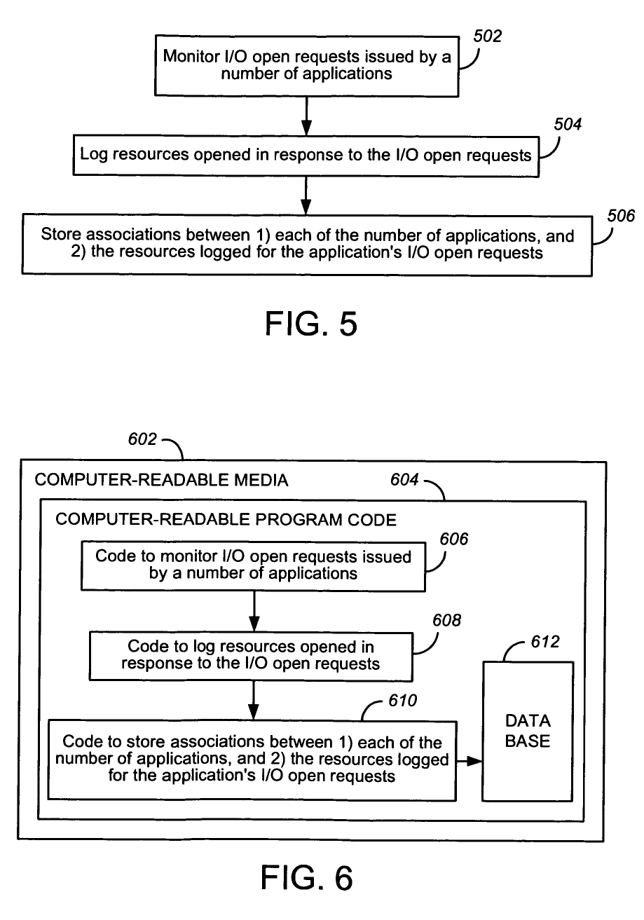

FIG. 5 illustrates a method 500 that may be implemented in association with, or in addition to, the method 200 shown in FIG. 2. The method 500 comprises monitoring 502 I/O open requests issued by a number of applications, and then logging 504 resources that are opened in response to the I/O open requests. Associations between 1) each of the number of applications, and 2) the resources logged for the application's I/O open requests, are then stored 506.

Similarly to the method 200, the method 500 may be implemented by an I/O configuration utility 600 (FIG. 6). As shown, the utility 600 may be embodied in computer-readable program code 604 stored on a number of computer-readable media 602. The code may comprise code 606 to monitor I/O open requests issued by a number of applications; code 608 to log resources opened in response to the I/O open requests; and code 610 to store associations between 1) each of the number of applications, and 2) the resources logged for the application's I/O open requests. By way of example, the associations may be stored in various locations or structures, such as a file or database 612.

Various alternative and optional embodiments of the method 500 and utility 600 will now be described.

In one embodiment, the method 500 or utility 600 may issue identification queries to resources that have been newly logged in the database 612. In this manner, various pieces of information regarding a resource may be acquired and logged into the database 612 (including, preferably, at least a name and a location path (e.g., file path) of each resource).

Upon deployment of an application to a new computer system, the associations stored in the database 612 may be accessed to identify a first set of resources associated with the application. Configured I/O interfaces of the new computer system may then be analyzed to attempt to identify a second set of resources that is capable of fulfilling the functions of the first set of resources. If a resource that is to be included in the second set of resources is identified, future I/O open requests that are directed to the resource logged in the database 612 are caused to be redirected to the identified resource of the new computer system. This may be done, for example, by changing an identifier of an I/O interface corresponding to the identified resource, or by creating an alias to associate the name of the resource logged in the database 612 with the identified resource.

Upon failure to identify a resource capable of fulfilling the functions of one of the resources logged in the database 612, an application user may be informed of this fact and may be provided a list of resources that may be able to fulfill the functions of the resource. A suitable resource may then be selected, and either an alias may be created, or an I/O interface identifier may be changed, as described with respect to the method 200 and utility 300. In this manner, I/O may be automatically configured (or at least semi-automatically configured) for the re-deployed application.

In some cases, the monitoring of I/O open requests may be automatically initiated upon boot of a computer system, upon change of a computer system's connected resources, or upon deployment of a new application on a computer system. In one embodiment, the method 500 or utility 600 is performed or invoked during a learning mode (which may function similarly to, or be the same as, the learning mode described with respect to the method 200 and utility 300).

In one embodiment, the code 606, 608, 610 is integrated with the code 306, 308.

What is claimed is:

1. A computer-implemented method for configuring I/O, comprising:
monitoring I/O open requests; and
upon failure of an I/O open request directed to a first resource,
analyzing configured I/O interfaces to attempt to identify a second resource capable of handling the I/O open request directed to the first resource; and
if the second resource is identified, causing future I/O open requests directed to the first resource to be redirected to the second resource.

2. The method of claim 1, wherein causing future I/O requests directed to the first resource to be redirected to the second resource comprises:
changing an identifier of an I/O interface corresponding to the second resource to match that of an I/O interface that corresponded to the first resource.

3. The method of claim 1, wherein causing future I/O requests directed to the first resource to be redirected to the second resource comprises:
creating an alias to associate the name of the first resource with the second resource.

4. The method of claim 1, further comprising, if, upon failure of the I/O open request, the second resource is not identified, advising a user of the failed I/O open request and providing a list of resources that may be able to satisfy the I/O open request.

5. An I/O configuration utility, comprising:
computer-readable program code to,
monitor I/O open requests; and
upon failure of an I/O open request directed to a first resource,
analyze configured I/O interfaces to attempt to identify a second resource capable of handling the I/O open request; and
if the second resource is identified, cause future I/O open requests directed to the first resource to be redirected to the second resource.

6. The utility of claim 5, wherein the code to cause future I/O requests directed to the first resource to be redirected to the second resource comprises:
code to change an identifier of an I/O interface corresponding to the second resource to match that of an I/O interface that corresponded to the first resource.

7. The utility of claim 1, wherein the code to cause future I/O requests directed to the first resource to be redirected to the second resource comprises:
code to create an alias to associate the name of the first resource with the second resource.

8. The utility of claim 5, further comprising computer-readable program code to, upon failure of the I/O open request, and upon the second resource not being identified, advise a user of the failed I/O open request and provide a list of resources that may be able to satisfy the I/O open request.

9. The utility of claim 8, further comprising computer-readable program code to, upon receiving a user's selection of one of the list of resources, create an alias to associate the name of the first resource with the selected one of the resources.

10. The utility of claim 8, further comprising computer-readable program code to, upon receiving a user's selection of one of the list of resources,
create a temporary alias to associate the name of the first resource with the selected one of the resources;
log I/O commands to the selected one of the resources; and
display, to the user, data being transmitted in response to the I/O commands.

11. The utility of claim 10, further comprising computer-readable program code to display to the user an option to make the temporary alias a permanent alias.

12. The utility of claim 8, further comprising computer-readable program code to, upon receiving a user's selection of one of the list of resources, prompt the user to indicate whether the selection is temporary or permanent.

13. The utility of claim 12, further comprising computer-readable program code to, upon receiving an indication that the user's selection of one of the list of resources is temporary,
log I/O commands to the selected one of the resources; and
display to the user data being transmitted in response to the I/O commands.

14. The utility of claim 13, further comprising computer-readable program code to display to the user an option to make the temporary alias a permanent alias.

15. The utility of claim 8, further comprising computer-readable program code to, upon receiving a user's selection of one of the list of resources, change an identifier of an I/O interface corresponding to the selected one of the resources to match that of an I/O interface that corresponded to the first resource.

16. The utility of claim 5, wherein said code to monitor, create and analyze performs these actions during a learning mode of the I/O configuration utility.

17. The utility of claim 5, wherein said code to monitor is automatically initiated upon change of a computer system's connected resources.

18. The utility of claim 5, wherein said code to monitor is automatically initiated upon deployment of a new application on a computer system.

19. The utility of claim 5, wherein the monitored I/O open requests comprise NI-488.2 and VISA/SICL open requests.

20. The utility of claim 5, wherein the analyzed I/O interfaces comprise USB, LAN, GPIB and RS-232 interfaces.

21. The utility of claim 5, wherein the attempt to identify the second resource is made by searching for a resource whose identification only varies from that of the first resource by interface number.

22. The utility of claim 5, wherein the resources comprise test and measurement instruments, and wherein the I/O open requests are intercepted from test and measurement applications.

23. A computer-implemented method, comprising:
monitoring I/O open requests issued by a number of applications;
logging resources opened in response to the I/O open requests; and
storing associations between i) each of the number of applications, and ii) the resources logged for the application's I/O open requests.

24. The method of claim 23, further comprising, issuing identification queries to newly logged resources.

25. The method of claim 23, wherein logging resources opened in response to the I/O open requests comprises logging at least a name and location path of each resource.

26. An I/O utility, comprising:
computer-readable program code to,
monitor I/O open requests issued by a number of applications;
log resources opened in response to the I/O open requests; and
store associations between i) each of the number of applications, and ii) the resources logged for the application's I/O open requests.

27. The utility of claim 26, further comprising computer-readable program code to issue identification queries to newly logged resources.

28. The utility of claim 26, further comprising computer-readable program code to, upon deployment of a particular one of the applications on a new computer system,
access the stored associations to identify a first set of resources associated with the particular application;
analyze configured I/O interfaces of the new computer system to attempt to identify a second set of resources, the second set of resources being capable of fulfilling functions of the first set of resources; and
if a particular resource to be included in the second set of resources is identified, cause future I/O open requests directed to a resource of the first set to be redirected to the particular resource.

29. The utility of claim 28, further comprising computer-readable program code to, upon failure to identify a resource capable of fulfilling the functions of a particular one of the first set of resources, advise a user of the particular application and provide a list of resources that may be able to fulfill the functions of the particular resource.

30. The method of claim 29, further comprising computer-readable program code to, upon receiving a user's selection of one of the list of resources, create an alias to associate the name of the particular resource with the selected one of the resources.

31. The method of claim 29, further comprising computer-readable program code to, upon receiving a user's selection of one of the list of resources,
create a temporary alias to associate the name of the particular resource with the selected one of the resources;
log I/O commands to the selected one of the resources; and
display to the user data being transmitted in response to the I/O commands.
